(19) United States
(12) Patent Application Publication
(10) Pub. No.: US 2012/0159042 A1
(43) Pub. Date: Jun. 21, 2012

(54) DATA STORAGE DEVICE EXECUTING A UNITARY COMMAND COMPRISING TWO CIPHER KEYS TO ACCESS A SECTOR SPANNING TWO ENCRYPTION ZONES

(75) Inventors: GLENN A. LOTT, BERTHOUD, CO (US); JEAN KODAMA, CERRITOS, CA (US); DANNY O. YBARRA, MISSION VIEJO, CA (US)

(73) Assignee: WESTERN DIGITAL TECHNOLOGIES, INC., Irvine, CA (US)

(21) Appl. No.: 12/974,379

(22) Filed: Dec. 21, 2010

(51) Int. Cl. G06F 12/02

(52) U.S. Cl. 711/103; 711/E12.008

(57) ABSTRACT

A data storage device is disclosed comprising a non-volatile memory (NVM) including a plurality of sectors each having a sector size. An access command is received from a host, wherein the access command identifies a plurality of host blocks having a host block size less than the sector size. A plurality of the host blocks are mapped to a target sector. When the target sector spans an encryption zone boundary defined by the host blocks, a NVM command is generated identifying a first key corresponding to a first encryption zone and a second key corresponding to a second encryption zone. The NVM command is executed as a unitary operation to access a first part of the target sector using the first key and access a second part of the target sector using the second key.

### BACKGROUND

Data storage devices (DSDs), such as disk drives and solid state drives are employed in numerous areas such as computer systems (e.g., desktops, laptops, portables, etc.) and consumer devices (e.g., music players, cell phones, cameras, etc.). User data is typically stored in a non-volatile memory (NVM), such as a magnetic disk or a non-volatile semiconductor memory (e.g., Flash memory). The NVM is accessed in segments of memory referred to as sectors, wherein the host block size may be disparate from the sector size. For example, a host may access a DSD with access commands specifying a host block size of 512 bytes, whereas the sector size of the NVM may be 2 k bytes. Accordingly, each sector of the NVM is capable of storing multiple host blocks (e.g., four host blocks in the foregoing example).

### BRIEF DESCRIPTION OF THE DRAWINGS

FIG. 1A shows a data storage device according to an embodiment of the present invention comprising a non-volatile memory (NVM) including a plurality of sectors.

FIG. 1B is a flow diagram according to an embodiment of the present invention wherein when a target sector spans an encryption zone boundary, a first and second encryption key are inserted into a single NVM command in order to access the target sector.

FIG. 1C shows an embodiment of the present invention wherein a target sector accessed when servicing a host command spans an encryption zone boundary.

FIG. 2A shows an overview of control blocks for servicing a host access command including an NVM interface that executes the single NVM command in order to access a target sector that spans an encryption zone boundary.

FIG. 2B shows an example NVM command including first and second key indexes for accessing first and second encryption zones having a boundary within a target sector.

FIG. 3 shows an embodiment of the present invention wherein the NVM comprises a disk of a disk drive.

FIG. 4 shows an embodiment of the present invention wherein the NVM comprises a non-volatile semiconductor memory.

### DETAILED DESCRIPTION OF EMBODIMENTS OF THE INVENTION

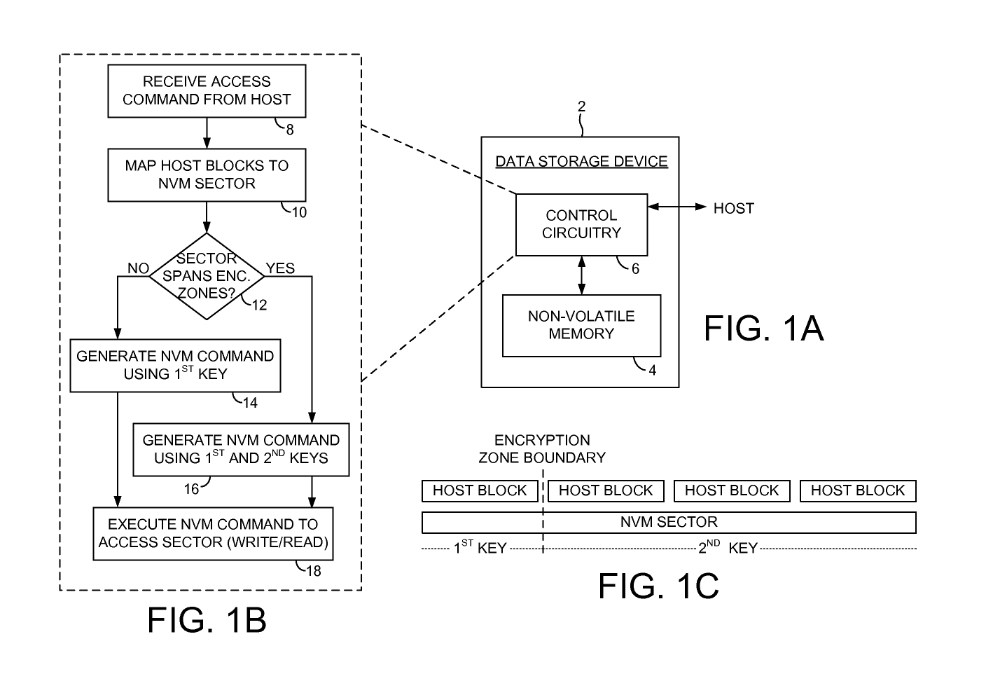

FIG. 1A shows a data storage device 2 according to an embodiment of the present invention comprising a non-volatile memory (NVM) 4 including a plurality of sectors each having a sector size. The data storage device 2 further comprises control circuitry 6 operable to execute the flow diagram of FIG. 1B. An access command is received from a host (step 8), wherein the access command identifies a plurality of host blocks having a host block size less than the sector size. A plurality of the host blocks are mapped to a target sector (step 10). When the target sector spans an encryption zone boundary defined by the host blocks (step 12), a NVM command is generated identifying a first key corresponding to a first encryption zone and a second key corresponding to a second encryption zone (step 16). The NVM command is executed as a unitary operation to access a first part of the target sector using the first key and access a second part of the target sector using the second key (step 18). If the target sector does not span an encryption zone boundary (step 12), the NVM command is generated identifying a key corresponding to the single encryption zone (step 14).

In one embodiment, each host block of an access command is assigned a logical block address (LBA) that is mapped to a physical block address (PBA) representing a corresponding part of an NVM sector. An integer number of host blocks are mapped to an NVM sector, such as mapping four 515 byte host blocks to a 2 k byte NVM sector. In one embodiment, a plurality of encryption zone boundaries are defined relative to the host LBAs, wherein an encryption zone boundary may occur within a NVM sector. This is illustrated in FIG. 1C wherein a host access command comprises host blocks having LBAs that span an encryption zone boundary, and the encryption zone boundary occurs within the corresponding NVM sector. When this happens, an NVM command is generated to service the host access command using first and second keys each corresponding to their respective encryption zones so that the NVM command can be executed as a unitary operation.

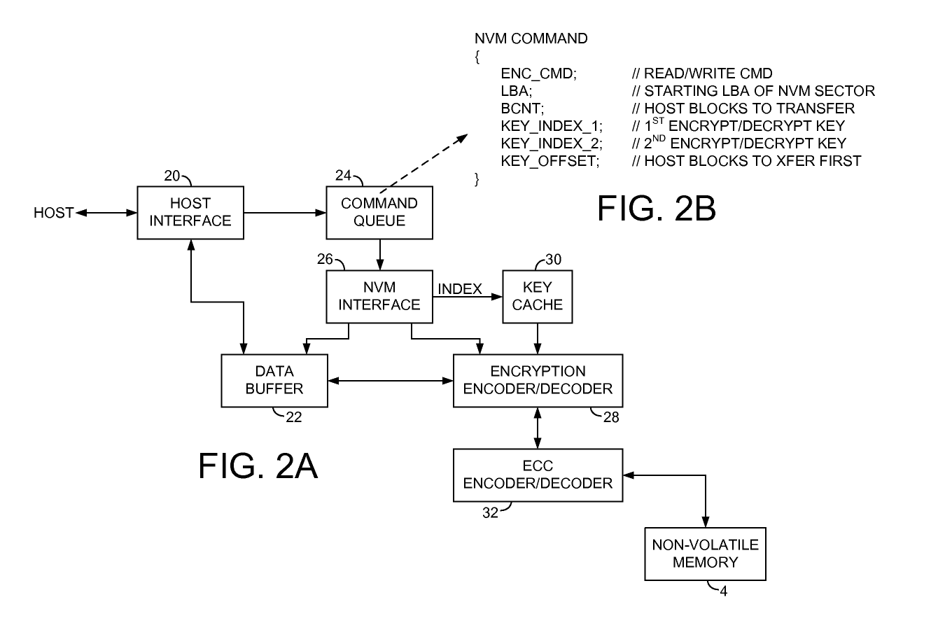

FIG. 2A shows an overview of control blocks within the data storage device according to an embodiment of the present invention, including a host interface 20 operable to receive access commands (write/read) from a host. When a write command is received, the write data in the host blocks is stored in a data buffer 22 and the LBAs of the host blocks are mapped to one or more NVM sectors. The host interface 20 generates one or more NVM commands that are stored in a command queue 24, wherein at least one of the NVM commands may identify first and second keys if a corresponding NVM sector spans an encryption boundary. An NVM interface 26 executes the NVM commands in the command queue 24 by transferring the write data in the data buffer 22 to an encryption encoder/decoder 28. The NVM interface extracts a first key from the NVM command to encrypt a first part of the write data, and if an NVM sector in the NVM command spans an encryption zone boundary, the NVM interface extracts a second key from the NVM command to encrypt a second part of the write data when reached. Any suitable encryption algorithm and attendant encryption/decryption keys may be employed in the present invention, including any symmetric or asymmetric key encryption algorithm such as Rivest, Shamir and Adleman (RSA) or Diffie-Hellman.

In one embodiment, the NVM command comprises a key index which is used to index a key cache 30 that is preloaded with a number of keys prior to executing the NVM command (e.g., pre-loaded with the first and second keys of first and second encryption zones). When executing the NVM command, the NVM interface 26 indexes the key cache 30 to quickly provide the appropriate key to the encryption encoder/decoder 28 when an encryption zone boundary is reached.

After encrypting the write data, in one embodiment the encrypted write data is further encoded by an error correction code (ECC) encoder/decoder 32, and the ECC encoded data is written to the NVM 4. Any suitable ECC algorithm may be employed to encode the encrypted write data, such as any suitable block code such as a Reed-Solomon code, or any suitable iterative code such as a low-density parity-check (LDPC) code.

When a read command is received from the host, the host interface evaluates the LBAs of the read command to generate one or more NVM commands stored in the command queue 24, wherein at least one of the NVM commands may identify first and second keys if a corresponding NVM sector spans an encryption boundary. The NVM interface 26 executes an NVM command in the command queue 24 by configuring the encryption encoder/decoder 28 with the appropriate key from the key cache 30. The data from an NVM sector is then read from the NVM 4 and decoded by the ECC encoder/decoder 32 into encrypted data that is decrypted by the encryption encoder/decoder 28. The decrypted data is transferred to the data buffer 22 and ultimately transferred to the host by the host interface 20. If the NVM sector spans an encryption boundary, the NVM interface 26 configures the encryption encoder/decoder 28 with a second key identified by the NVM command when the encryption boundary is reached (e.g., by indexing the key cache 30).

FIG. 2B shows an example data structure for implementing an NVM command including a command type field (ENC_CMD) that identifies the type of access command (read/write), an LBA field for storing a starting LBA of a corresponding NVM sector, and a block count field (BCNT) that identifies a number of host blocks to transfer. A first key index field stores a first index into the key cache 30 for a first encryption zone, and if the LBA range identified by the NVM command spans an encryption boundary, a second key index field stores a second index into the key cache 30 for the second encryption zone. An offset field (KEY_OFFSET) stores the number of host blocks to transfer to the first encryption zone before reaching the encryption zone boundary. The NVM interface 26 uses this field to determine when to select the second key from the key cache 30 as the NVM command is executed.

In the embodiment of FIG. 2B, the data structure comprises fields for supporting an NVM command that spans two encryption zones. However, other embodiments may comprise additional or different types of fields for supporting an NVM command that spans any number of encryption zones (e.g., by implementing an array of key indexes that supports three or more encryption zones). In addition, the NVM command may identify more than one starting LBA of a corresponding NVM sector, as well as multiple corresponding host block counts in order to access the NVM sector in multiple noncontiguous segments using a single NVM command.

The key cache 30 in the embodiment of FIG. 2A provides a mechanism for changing the encryption key on-the-fly as an NVM command is being executed and an encryption zone boundary is reached. The key cache 30 is preloaded with the appropriate keys corresponding to NVM commands that are queued for execution. For example, as a current NVM command is being executed, the key cache 30 for the next NVM command may be preloaded with the corresponding keys. In this manner, the keys can be applied on-the-fly to the encryption encoder/decoder 28 when the next command is executed. The key cache 30 may store any suitable number of keys to support any suitable number of pending NVM commands, as well as any suitable number of encryption zones that a single NVM command may span.

In other embodiments, the data structure of the NVM command may itself comprise the actual keys applied to the encryption encoder/decoder 28 rather than an index into a key cache. When the NVM command is executed, the keys may be preloaded into registers of the encryption encoder/decoder 28 and then the appropriate register selected as an encryption zone boundary is reached.

In one embodiment of the present invention, defining the encryption zones relative to the LBAs of the host blocks allows the user of the host system to select the encryption zone boundaries independent of the sector format of the NVM 4. When an encryption zone boundary is selected such that it falls within an NVM sector, the embodiments of the present invention enable access to the NVM sector as a unitary operation by implementing multiple keys within the corresponding NVM command. Employing a key cache or configurable key registers enables the appropriate keys to be selected on-the-fly as an encryption zone boundary is reached when executing the NVM command.

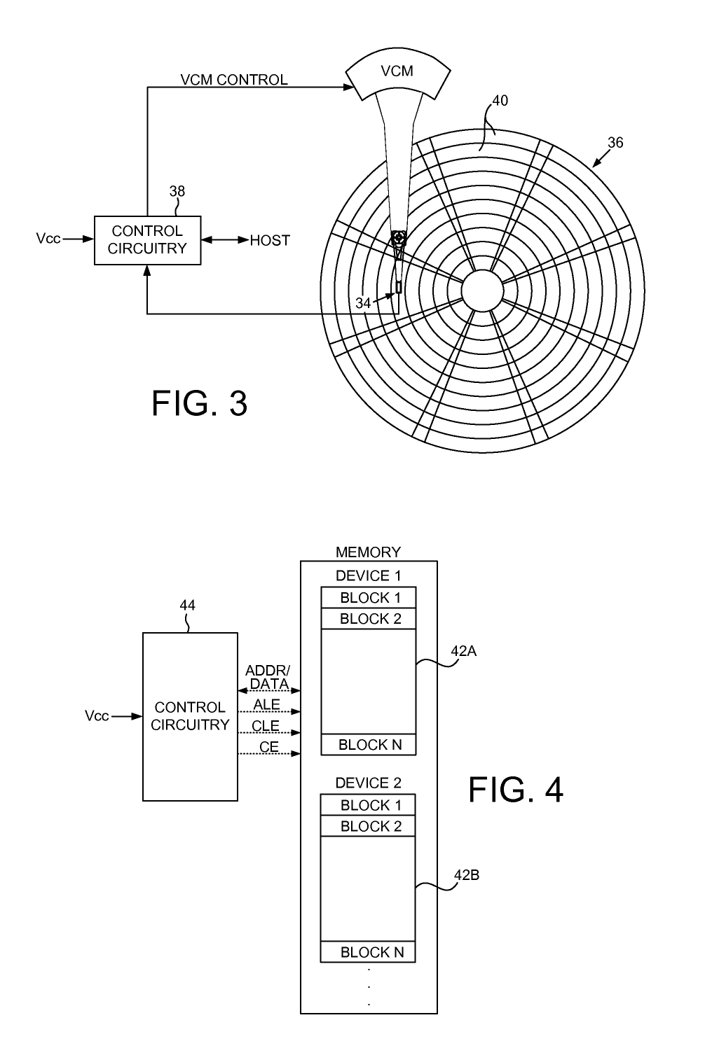

The embodiments of the present invention may be employed in any suitable DSD comprising any suitable non-volatile memory. FIG. 3 shows a DSD comprising a disk drive including a head 34 actuated over a disk 36 and control circuitry 38. The disk 36 comprises a plurality of data tracks 40, where each data track may comprise one or more sectors. FIG. 4 shows a DSD comprising a solid state drive including a plurality of non-volatile semiconductor memories 42A, 42B, etc., such as flash memories, and control circuitry 44. In one embodiment, each non-volatile semiconductor memory may comprise a plurality of blocks, each block may comprise a plurality of pages, and each page may comprise one or more sectors. A hybrid DSD may also be employed comprising components of a disk drive shown in FIG. 3 combined with the non-volatile semiconductor memories shown in FIG. 4.

Any suitable control circuitry 6 (FIG. 1A) may be employed in the embodiments of the present invention, such as one or more integrated circuits. In one embodiment, the control circuitry 6 comprises a microprocessor executing instructions, the instructions being operable to cause the microprocessor to perform the steps of the flow diagrams described herein. The instructions may be stored in any computer-readable medium. In one embodiment, they may be stored on a non-volatile semiconductor memory external to the microprocessor, or integrated with the microprocessor in a SOC. In another embodiment, the instructions are stored in a non-volatile memory and read into a volatile semiconductor memory when the DSD is powered on. In yet another embodiment, the control circuitry comprises suitable logic circuitry, such as state machine circuitry.

What is claimed is:

1. A data storage device comprising:
a non-volatile memory (NVM) comprising a plurality of sectors each having a sector size; and
control circuitry operable to:
receive an access command from a host, wherein the access command identifies a plurality of host blocks having a host block size less than the sector size;
map a plurality of the host blocks to a target sector;
when the target sector spans an encryption zone boundary defined by the host blocks, generate a NVM command identifying a first key corresponding to a first encryption zone and a second key corresponding to a second encryption zone; and
execute the NVM command as a unitary operation to access a first part of the target sector using the first key and access a second part of the target sector using the second key.

2. The data storage device as recited in claim 1, wherein when the target sector does not span the encryption zone boundary, the control circuitry is operable to:
generate the NVM command identifying the first key corresponding to the first encryption zone; and
execute the NVM command as a unitary operation to access the target data sector using the first key.

3. The data storage device as recited in claim 1, wherein the control circuitry comprises:
a host interface operable to receive the access command from the host and generate the NVM command; and
a NVM interface operable to execute the NVM command as a unitary operation.

4. The data storage device as recited in claim 3, wherein the control circuitry further comprises a key cache for storing the first key and the second key.

5. The data storage device as recited in claim 4, wherein the NVM command comprises a first index for identifying the first key in the key cache and a second index for identifying the second key in the key cache.

6. The data storage device as recited in claim 1, wherein the NVM comprises a disk.

7. The data storage device as recited in claim 1, wherein the NVM comprises a non-volatile semiconductor memory.

8. A method of operating a data storage device comprising a non-volatile memory (NVM) comprising a plurality of sectors each having a sector size, the method comprising:
receiving an access command from a host, wherein the access command identifies a plurality of host blocks having a host block size less than the sector size;
mapping a plurality of the host blocks to a target sector;
when the target sector spans an encryption zone boundary defined by the host blocks, generating a NVM command identifying a first key corresponding to a first encryption zone and a second key corresponding to a second encryption zone; and
executing the NVM command as a unitary operation to access a first part of the target sector using the first key and access a second part of the target sector using the second key.

9. The method as recited in claim 8, wherein when the target sector does not span the encryption zone boundary, further comprising:
generating the NVM command identifying the first key corresponding to the first encryption zone; and
executing the NVM command as a unitary operation to access the target data sector using the first key.

10. The method as recited in claim 8, wherein the data storage device comprises:
a host interface operable to receive the access command from the host and generate the NVM command; and
a NVM interface operable to execute the NVM command as a unitary operation.

11. The method as recited in claim 10, wherein the data storage device further comprises a key cache for storing the first key and the second key.

12. The method as recited in claim 11, wherein the NVM command comprises a first index for identifying the first key in the key cache and a second index for identifying the second key in the key cache.

13. The method as recited in claim 8, wherein the NVM comprises a disk.

14. The method as recited in claim 8, wherein the NVM comprises a non-volatile semiconductor memory.
